(19) United States
(12) Patent Application Publication
(10) Pub. No.: US 2012/0155306 A1
(43) Pub. Date: Jun. 21, 2012

(54) BASE STATION AND OPERATING METHOD THEREOF

(75) Inventors: Won-Ik KIM, Daejeon (KR); Woo-Goo PARK, Daejeon (KR); Pyeong Jung SONG, Daejeon (KR); Gyung-chul SIHN, Daejeon (KR); Jin Ho HAHM, Daejeon (KR)

(73) Assignee: Electronics and Telecommunications Research Institute, Daejeon (KR)

(21) Appl. No.: 13/327,622

(22) Filed: Dec. 15, 2011

(30) Foreign Application Priority Data
Dec. 17, 2010 (KR) 10-2010-0130170

(51) Int. Cl. H04W 24/00

(52) U.S. Cl. 370/252

(57) ABSTRACT

A base station measures an amount of traffic within a downlink buffer. If the measured amount of traffic is larger than a threshold value, the base station adjusts a ratio of an available interval and an unavailable interval according to a ratio of the amount of traffic against the threshold value and length of a superframe. If the measured amount of traffic is smaller than the threshold value, the base station adjusts a ratio of the available interval and the unavailable interval according to a ratio of the threshold value against the amount of traffic and length of the superframe.

### CROSS-REFERENCE TO RELATED APPLICATION

This application claims priority to and the benefit of Korean Patent Application No. 10-2010-0130170 filed in the Korean Intellectual Property Office on Dec. 17, 2010, the entire contents of which are incorporated herein by reference.

### BACKGROUND OF THE INVENTION

(a) Field of the Invention

The present invention generally relates a base station and an operating method of the base station. In particular, the present invention generally relates to a low-power mode operating method of the base station.

(b) Description of the Related Art

According to a conventional art, a femto-cell base station is managed in a low-power mode for reducing electromagnetic wave interference of the femto-cell base station and reducing power consumption. This low-power mode is called a base station low-duty mode or a base station power saving mode. When there are no mobile stations accessing the femto-cell base station or all accessing mobile stations are in an idle state, the femto-cell base station in the low-power mode discontinuously transmits and receives. That is, the femto-cell base station creates an available interval (AI) and an unavailable interval (UAI), and does not consume power in the unavailable interval. This can prevent interference between a macro-cell and an adjacent femto-cell.

FIG. 1 shows a base station low-power mode scheme according to a conventional embodiment.

Referring to FIG. 1, a low-duty cycle for a low-power mode of the base station consists of available intervals (AIs) and unavailable intervals (UAIs). In an available interval (AI), the base station can synchronize with the mobile station, and perform signaling such as paging, ranging, and data traffic transmission opportunities. The available interval (AI) is established in units of superframes, and periodically occurs. In the unavailable interval (UAI), the base station does not perform communication with the mobile station, which minimizes power consumption. The unavailable interval (UAI) can be established by considering the scanning performance of the mobile station.

According to the conventional art, the low-power mode management for the base station is only for the femto-cell base station. In particular, the conventional art is designed under the assumption that the number of subscribers using the corresponding femto-cell base station is extremely limited, so the conventional art is not suitable for base stations having larger service coverage than coverage of the micro-cell that has relatively more subscribers than the femto-cell. According to the conventional art, because the low-duty cycle is fixed and scheduling for the transmitting/receiving traffic for the mobile station is not performed, if the conventional art is applied to the micro-cell base station having a greater occurrence probability of the active mobile station than the femto-cell, the corresponding micro-cell base station cannot generate an unavailable interval (UAI), so there are few cases of the low-power mode operation.

Recently, the necessity of the low-power mode operation has been raised not only in the femto-cell base station but also in the base station having wide coverage such as the micro-cell base station. Also, in an area and time that traffic of the active mobile station does not frequently occur, the necessity for a method for reducing the power consumption through this base station low-power mode operation exists.

### SUMMARY OF THE INVENTION

Embodiments of the present invention provide a base station and operating method of the base station for minimizing unnecessary power consumption without exerting influence on quality of service (QoS) of active mobile stations within the base station.

An embodiment of the present invention provides an operation method of a base station, including measuring an amount of traffic within a downlink buffer; and adjusting a first ratio of an available interval and an unavailable interval according to the amount of traffic.

Adjusting the first ratio may include comparing the amount of traffic with a threshold value to adjust the first ratio according to comparison degree.

Comparing the amount of traffic may include determining a second ratio of the amount of traffic against the threshold value if the amount of traffic is larger than the threshold value; and adjusting the first ratio according to the second ratio.

Adjusting the first ratio according to the second ratio may include lengthening the available interval by multiplication of a length of a superframe and the second ratio; and shortening the unavailable interval by multiplication of the length of the superframe and the second ratio.

Comparing the amount of traffic further may include ceasing adjustment of the first ratio if a length of a current unavailable interval corresponds to 0.

Comparing the amount of traffic may include determining a second ratio of the threshold value against the amount of traffic, if the amount of traffic is smaller than the threshold value; and adjusting the first ratio according to the second ratio.

Adjusting the first ratio according to the second ratio may include shortening the available interval by multiplication of a length of a superframe and the second ratio; and lengthening the unavailable interval by multiplication of the length of the superframe and the second ratio.

Adjusting the first ratio according to the second ratio further may include ceasing adjustment of the first ratio if a length of a current available interval corresponds to a minimum available interval length.

The operation method may further include broadcasting information on the first ratio.

Another embodiment of the present invention provides a base station, including a traffic amount checker for measuring an amount of traffic within a downlink buffer; and a mode operation controller for adjusting a first ratio of an available interval and an unavailable interval according to the amount of traffic.

The mode operation controller may compare the amount of traffic with a threshold value to adjust the first ratio according to comparison degree.

The mode operation controller may adjust the first ratio according to a second ratio of the amount of traffic against the threshold value and a length of a superframe if the amount of traffic is larger than the threshold value, wherein the mode operation controller adjusts the first ratio according to a third ratio of the threshold value against the amount of traffic and a length of a superframe if the amount of traffic is smaller than the threshold value.

The base station may further include an information broadcasting unit for broadcasting information on the first ratio.

Yet another embodiment of the present invention provides an operation method of a base station having a plurality of systems, including obtaining information on lengths of unavailable intervals of the plurality of systems; and if a first system with an unavailable interval of which length is 0 exists, transmitting a message for instructing handover into the first system to a mobile station operating in a second system with an unavailable interval of which length is not 0.

The operation method may further include adjusting a ratio of an available interval and the unavailable interval for the second system.

According to an embodiment of the present invention, a base station having a plurality of systems includes an information obtainer for obtaining information on lengths of unavailable intervals of the plurality of systems; and a handover instruction message transmitter for transmitting a message for instructing handover into a first system to a mobile station operating in a second system with an unavailable interval of which length is not 0, if the first system with an unavailable interval of which length is 0 exists.

The base station may further include a mode operation controller for adjusting a ratio of an available interval and the unavailable interval for the second system.

### BRIEF DESCRIPTION OF THE DRAWINGS

FIG. 1 shows a base station low-power mode scheme according to a conventional embodiment.

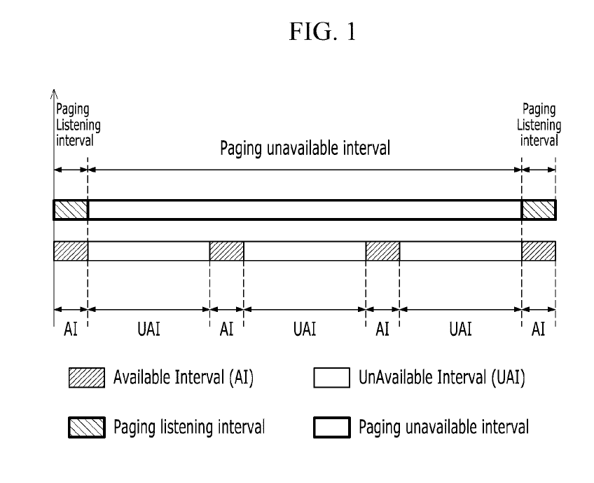

FIG. 2 shows dynamic traffic recognition low-power mode operation according to an embodiment of the present invention.

FIG. 3 is a flowchart showing operation of a base station according to an embodiment of the present invention.

FIG. 4 shows a block diagram of a base station according to an embodiment of the present invention.

FIG. 5 shows a block diagram of a base station according to another embodiment of the present invention.

FIG. 6 is a flowchart showing operation of a base station according to another embodiment of the present invention.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In this specification, a mobile station (MS) may designate a terminal, an advanced mobile station (AMS), a mobile terminal (MT), a subscriber station (SS), a portable subscriber station (PSS), user equipment (UE), an access terminal (AT), etc., and may include the entire or partial functions of the mobile terminal, the subscriber station, the portable subscriber station, the user equipment, etc.

In this specification, a base station (BS) may designate an access point (AP), an advanced base station (ABS), a radio access station (RAS), a Node B, a base transceiver station (BTS), a mobile multihop relay (MMR)-BS, etc., and may include the entire or partial functions of the access point, the radio access station, the node B, the base transceiver station, the MMR-BS, etc.

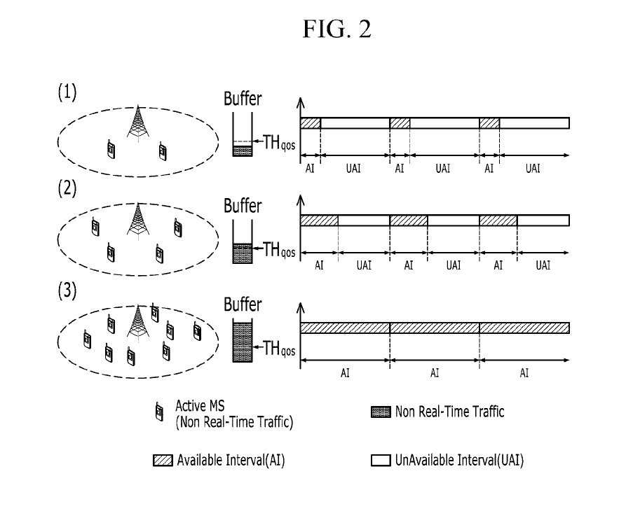

Referring to FIGS. 2 to 4, operation of the base station according to an embodiment of the present invention will be described.

FIG. 2 shows dynamic traffic recognition low-power mode operation according to an embodiment of the present invention.

In a sparsely-populated area or very late at night, the number of mobile stations used is small. In particular, real-time traffic is rarely generated.

Even in a downtown area with many offices and factories, there are many terminal users in the daytime, but there are few terminal users in the very late night. In this case, even though there is an active mobile station, the base station manages non-real-time traffic of the active mobile station in the low-power mode, so the base station minimizes power consumption.

As shown in FIG. 2 (1), if the amount of generated traffic is small so that it can be treated without lowering the quality of service (QoS) of the active mobile station within the available intervals that are repeatedly generated for the low-duty cycle, the base station maintains an initial established low-duty cycle and transmits traffic to the active mobile station within the available intervals.

In an embodiment of the present invention, the following variables can be used for determining whether the QoS of the active mobile station is reduced.

A variable BUFtraffic represents a total amount of traffic inputted to a downlink buffer of the base station.

A variable THqos corresponds to a threshold value for determining whether the total amount of traffic inputted to a downlink buffer of the base station is large or small and for determining whether the QoS of the active mobile station is reduced. An initial THqos value is set based on the amount of traffic within the downlink buffer of the base station and variation of QoS of the active mobile station.

As shown in FIG. 2 (2), if the amount BUFtraffic of traffic inputted to the downlink buffer of the base station during the unavailable interval (UAI) exceeds the threshold value THqos, the base station determines that the QoS of the active mobile station is reduced, and increases the downlink transmission opportunity of the base station by increasing the size of available intervals (AIs) of the low-duty cycle. When the size of available intervals (AIs) is changed as described above, the base station notifies at least one of low-duty cycle information, available interval (AI) information, and unavailable interval (UAI) information through an advertisement message to MSs.

As shown in FIG. 2 (3), if there are many active mobile stations within the base station, the size of available intervals (AIs) continually increases in order to increase transmission opportunity of the base station. Finally, the size of unavailable intervals (UAIs) may become 0. This is the same as the normal operation mode of the base station. In an embodiment of the present invention, the case where the size of unavailable intervals (UAIs) is equal to 0 is classified as transition into the normal operation mode of the base station. Like the case of FIG. 2 (2), because the size of available intervals (AIs) has been changed, the base station notifies low-duty cycle information through the advertisement message to MSs.

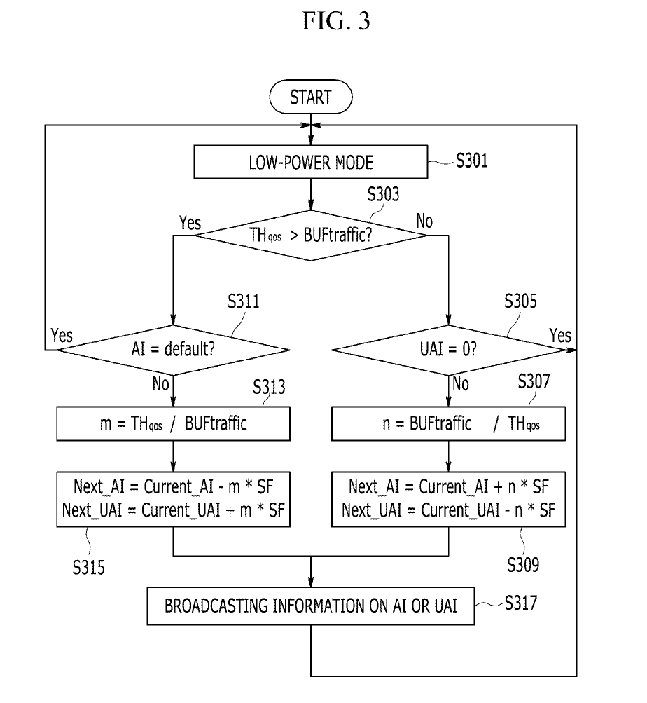

FIG. 3 is a flowchart showing operation of a base station according to an embodiment of the present invention. In particular, FIG. 3 shows operation of a dynamic traffic recognition low-power mode of the base station.

First, the base station operates in the low-power mode in step S301.

Next, the base station compares the amount BUFtraffic of traffic of the downlink buffer with the threshold value THqos for each low-duty cycle in step S303.

If the amount BUFtraffic of traffic of the downlink buffer is larger than the threshold value THqos, the base station checks whether the length of the current unavailable interval (UAI) is 0 in step S305.

If the length of the current unavailable interval (UAI) is 0, the base station determines that there is no increasable available interval, and maintains the current available interval (AI).

Otherwise, if the length of the current unavailable interval (UAI) is not 0, the base station calculates a degree n by which the amount BUFtraffic of traffic exceeds the threshold value THqos in step S307. The degree n can be calculated according to Equation 1.

n=BUFtraffic/THqos, where n is an integer (Equation 1)

Next, the base station increases the length of the available interval (AI) according to the degree n and decreases the length of the unavailable interval (UAI) by the amount of increase of the length of the available interval (AI) in step S309. As shown in Equation 2, the base station may increase the length of the available interval (AI) by the length corresponding to n superframes and decrease the length of the unavailable interval (UAI) by the length corresponding to n superframes.

Next_AI=Current_AI+n*SF

Next_UAI=Current_UAI−n*SF (Equation 2)

In Equation 2, the variable Next_AI represents the length of the available interval (AI) to be changed, the variable Current_AI represents the length of the current available interval (AI), the variable Next_UAI represents the length of the unavailable interval (UAI) to be changed, the variable Current_UAI represents the length of the current unavailable interval (UAI), and SF represents the length of one superframe.

On the other hand, if the amount BUFtraffic of traffic of the downlink buffer is smaller than the threshold value THqos, the base station determines whether or not the length of the current available interval (AI) is equal to the length of the initial available interval or the length of the minimum available interval in step S311.

If the length of the current available interval (AI) is equal to the length of the initial available interval or the length of the minimum available interval, the base station determines that there is no available interval (AI) to further decrease, and maintains the current available interval (AI).

If the length of the current available interval (AI) is longer than the length of the initial available interval or the length of the minimum available interval, the base station calculates a degree m by which the threshold value THqos exceeds the amount BUFtraffic of traffic of the downlink buffer in step S313. The degree m may be calculated according to Equation 3.

m=THqos/BUFtraffic, where m is an integer (Equation 3)

Next, the base station decreases the length of the available interval (AI) according to the degree m and increases the length of the unavailable interval (UAI) by the amount of decrease of the length of the available interval (AI) in step S315. As shown in Equation 4, the base station may decrease the length of the available interval (AI) by the length of m superframes, and increase the length of the unavailable interval (UAI) by the length of m superframes.

Next_AI=Current_AI−m*SF

Next_UAI=Current_UAI+m*SF (Equation 4)

When the length of the available interval (AI) and the length of the unavailable interval (UAI) are changed, the base station notifies information on the changed available interval (AI) and the changed unavailable interval (UAI) through the advertisement message to the mobile station in step S317. If the active mobile station receives the advertisement message from the base station, the active mobile station can have the uplink transmission opportunity according to the changed available interval (AI).

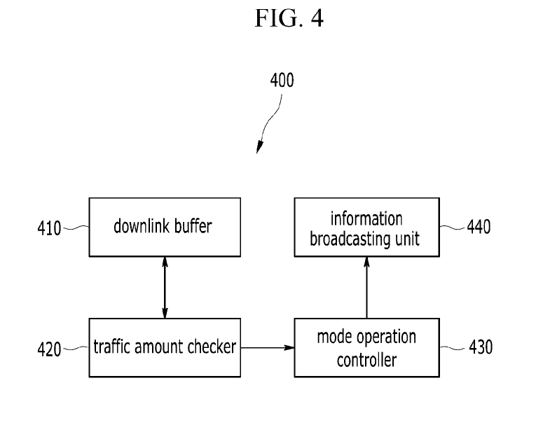

FIG. 4 shows a block diagram of a base station according to an embodiment of the present invention.

As shown in FIG. 4, a base station 400 according to an embodiment of the present invention includes a downlink buffer 410, a traffic amount checker 420, a mode operation controller 430, and an information broadcasting unit 440.

The traffic amount checker 420 checks an amount of downlink traffic within the downlink buffer 410 to provide information on the amount of downlink traffic to the mode operation controller 430.

The mode operation controller 430 compares the amount of downlink traffic within the downlink buffer 410 with the threshold value THqos to change the length of the available interval (AI) and the length of the unavailable interval (UAI) as shown in FIG. 3.

The information broadcasting unit 440 generates and broadcasts information on the changed length of the available interval (AI) and the changed length of the unavailable interval (UAI).

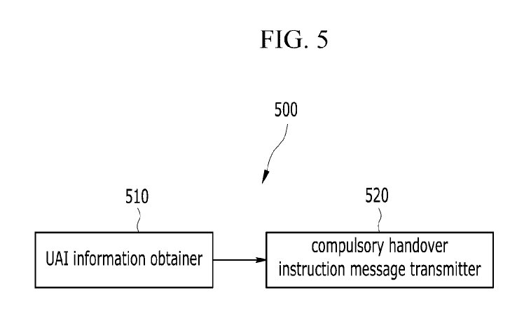

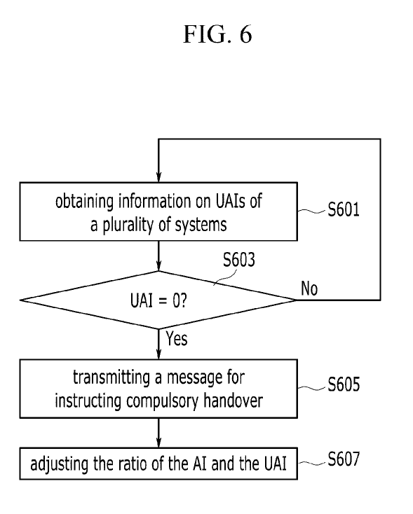

Also, a multi-mode multi-band base station with various heterogeneous systems performs compulsory handover of the active mobile stations to a system with the unavailable interval (UAI) of 0, so induces a system with the relatively large unavailable interval (UAI) to minimize power consumption. Hereinafter, referring to FIG. 5 and FIG. 6, operation of the base station according to another embodiment of the present invention will be described.

FIG. 5 shows a block diagram of a base station according to another embodiment of the present invention.

As shown in FIG. 5, a base station 500 according to the current embodiment of the present invention includes a UAI information obtainer 510 and a compulsory handover instruction message transmitter 520. In particular, the base station 500 according to the embodiment in relation to FIG. 5 may include a plurality of communication systems, and may further include constituent elements of FIG. 4 for each communication system. Referring to FIG. 6, functions of the base station 500 will be described.

FIG. 6 is a flowchart showing operation of a base station according to another embodiment of the present invention.

As shown in FIG. 6, the UAI information obtainer 510 obtains information on the length of the unavailable interval (UAI) of a plurality of systems in step S601.

Next, the compulsory handover instruction message transmitter 520 checks whether a system with an unavailable interval (UAI) whose length is equal to 0 exists among the plurality of systems in step S603. In particular, the base station may check whether a system of the normal operation mode exists among the plurality of systems.

If a system with the unavailable interval (UAI) whose length is equal to 0 exists or a system of the normal operation mode exists, the compulsory handover instruction message transmitter 520 transmits, to active mobile stations within a cell of a system with the unavailable interval (UAI) whose length is not equal to 0, a message for instructing compulsory handover to the system with the unavailable interval (UAI) whose length is equal to 0 or the system of the normal operation mode in step S605.

Because the number of active mobile stations operating in the system with the unavailable interval (UAI) whose length is not equal to 0 decreases, the mode operation controller 430 of the system with the unavailable interval (UAI) whose length is not equal to 0 adjusts the ratio of the available interval (AI) and the unavailable interval (UAI) as shown in FIG. 3 in step S607.

Various embodiments were described above referring to FIG. 3 to FIG. 6, respectively. However, functions of the base stations described referring to FIG. 3 to FIG. 6 may be combined.

According to aspects of the present invention, by dynamically changing the low-duty cycle according to the amount of traffic, it is possible to minimize unnecessary power consumption of base stations having larger service coverage than coverage of a micro-cell, without exerting influence on quality of service (QoS) of active mobile stations within the base station. Further, it is possible to reduce electromagnetic wave interference between cells.

Also, the multi-mode multi-band base station can be operated in a more effective low-power mode through the compulsory handover to a system with the unavailable interval (UAI) whose length is 0.

The embodiments of the present invention are not implemented only by a device and/or method, but can be implemented through a program for realizing functions corresponding to the configuration of the embodiments of the present invention and a recording medium having the program recorded thereon. These implementations can be realized by the ordinarily skilled person in the art from the description of the above-described embodiment.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. An operation method of a base station, comprising:
measuring an amount of traffic within a downlink buffer; and
adjusting a first ratio of an available interval and an unavailable interval according to the amount of traffic.

2. The operation method of claim 1, wherein adjusting the first ratio comprises:
comparing the amount of traffic with a threshold value to adjust the first ratio according to comparison degree.

3. The operation method of claim 2, wherein comparing the amount of traffic comprises:
determining a second ratio of the amount of traffic against the threshold value if the amount of traffic is larger than the threshold value; and
adjusting the first ratio according to the second ratio.

4. The operation method of claim 3, wherein adjusting the first ratio according to the second ratio comprises:
lengthening the available interval by multiplication of a length of a superframe and the second ratio; and
shortening the unavailable interval by multiplication of the length of the superframe and the second ratio.

5. The operation method of claim 4, wherein comparing the amount of traffic further comprises:
ceasing adjustment of the first ratio if a length of a current unavailable interval corresponds to 0.

6. The operation method of claim 2, wherein comparing the amount of traffic comprises:
determining a second ratio of the threshold value against the amount of traffic, if the amount of traffic is smaller than the threshold value; and
adjusting the first ratio according to the second ratio.

7. The operation method of claim 6, wherein adjusting the first ratio according to the second ratio comprises:
shortening the available interval by multiplication of a length of a superframe and the second ratio; and
lengthening the unavailable interval by multiplication of the length of the superframe and the second ratio.

8. The operation method of claim 7, wherein adjusting the first ratio according to the second ratio further comprises:
ceasing adjustment of the first ratio if a length of a current available interval corresponds to a minimum available interval length.

9. The operation method of claim 2, further comprising broadcasting information on the first ratio.

10. A base station, comprising:
a traffic amount checker for measuring an amount of traffic within a downlink buffer; and
a mode operation controller for adjusting a first ratio of an available interval and an unavailable interval according to the amount of traffic.

11. The base station of claim 10, wherein the mode operation controller compares the amount of traffic with a threshold value to adjust the first ratio according to comparison degree.

12. The base station of claim 11, wherein the mode operation controller adjusts the first ratio according to a second ratio of the amount of traffic against the threshold value and a length of a superframe if the amount of traffic is larger than the threshold value,
wherein the mode operation controller adjusts the first ratio according to a third ratio of the threshold value against the amount of traffic and a length of a superframe if the amount of traffic is smaller than the threshold value.

13. The base station of claim 12, further comprising:
an information broadcasting unit for broadcasting information on the first ratio.

14. An operation method of a base station having a plurality of systems, comprising:
obtaining information on lengths of unavailable intervals of the plurality of systems; and
if a first system with an unavailable interval of which length is 0 exists, transmitting a message for instructing handover into the first system to a mobile station operating in a second system with an unavailable interval of which length is not 0.

15. The operation method of claim 14, further comprising:
adjusting a ratio of an available interval and the unavailable interval for the second system.

16. A base station having a plurality of systems, comprising:
an information obtainer for obtaining information on lengths of unavailable intervals of the plurality of systems; and
a handover instruction message transmitter for transmitting a message for instructing handover into a first system to a mobile station operating in a second system with an unavailable interval of which length is not 0, if the first system with an unavailable interval of which length is 0 exists.

17. The base station of claim 16, further comprising:
a mode operation controller for adjusting a ratio of an available interval and the unavailable interval for the second system.
